(19) United States
(12) Patent Application Publication
(10) Pub. No.: US 2005/0034396 A1
(43) Pub. Date: Feb. 17, 2005

(54) Insta French

(76) Inventor: Steven K. Collins, Grant, FL (US)

Correspondence Address: Steven K Collins, 2250 Cypress Lakes Drive, Grant, FL, 32949, US

(21) Appl. No.: 10/628,132

(22) Filed: Jul. 28, 2003

(51) Int. Cl. E06B 1/04

(52) U.S. Cl. 52/455

(57) ABSTRACT

Insta French is a vinyl insert that fits into standard doors and windows. Inserts are installed on the inside or outside of existing sliding glass doors or windows. Insta French Inserts have no outer edge or framing. The door or window edges provide the framing effect. The tabs on each cross bar with 1/16 of an inch extra vinyl slips under the window molding to hold the insert in the window. A cap is placed over the notched out vinyl to make the insert firm against the glass. Insta French inserts can be easily removed to clean window glass. They are easily reinstalled to give a glamorous French door look. Anyone can have a French door look without the pain rendering cleaning of small multiple panes of glass. No costly expense of replacing doors and windows. Insta French creates a whole new look in minutes.

### CROSS-REFERENCE TO RELATED APPLICATIONS

| | | |
|---|---|---|
| 3,441,258 | November 1968 | Kessier |
| 4,437,284 | March 1984 | Cribben & Ichter |
| 4,586,306 | May 1986 | weeb |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Not applicable

### BRIEF SUMMARY OF THE INVENTION

Insta French is a French door inserts that installs on the inside or outside of existing sliding glass doors or windows. The Insta French inserts attach to the inside of the doorframes or windows. No permanent fixtures are used. No tools are needed to install Insta French inserts. Insta French inserts can be easily removed for cleaning of window glass. Easily reinstalled to give a glamorous French door look. Insta French Inserts will come in various sizes and colors. To match existing door and window frames. Insta French Inserts has no outer edge or framing. The door or window provides the framing effect.

Anyone can have a French door look without the pain rendering cleaning of small multiple panes of glass. No costly expense of replacing doors and windows. Insta French creates a whole new look in minutes.

### BRIEF DESCRIPTION OF THE SEVERAL VIEWS OF THE DRAWINGS

FIG. 1 Insta French Inserts

FIG. 2 Insta French Inserted into door

FIG. 3 Measurements

FIG. 4 Notches—Corrected drawing

FIG. 5 Tabs—Corrected drawing

FIG. 6 Caps

### DETAILED DESCRIPTION OF THE INVENTION

This invention relates to multi pane Inserts these structures are disclosed in U.S. Pat. No. 3,441,258 to Milton Kesser entitled Plastic False Muntin For Windows, U.S. Pat. No. 4,437,284 to James Cribben & William Ichter, Entitled Snap-On False Muntin System, U.S. Pat. No. 4,586,306 to Dale Weeb entitled Window Assembly and Grille Retaining Strip Hardware There for.

Insta French is a continuation of the above patents the differences is that the Insta French Insert has no bracketing or retaining strips to attach to the window. The bracketing is made in each cross bar of the insert which slides into the window molding. Which make the Insta French insert more versatile to all windows and doors.

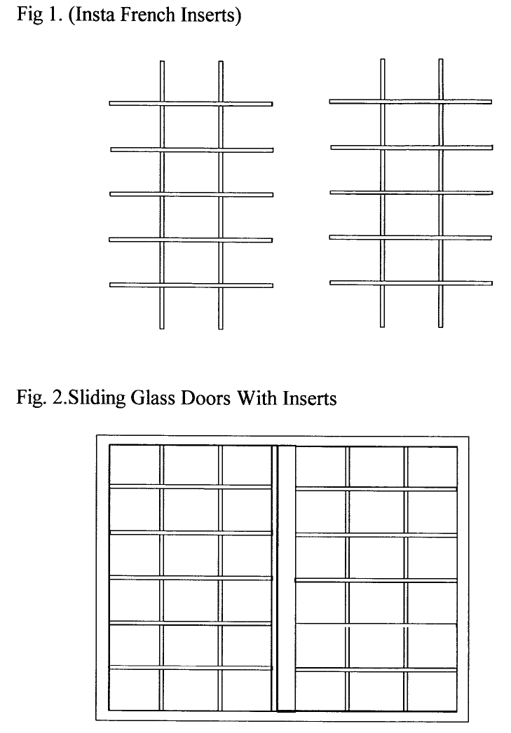

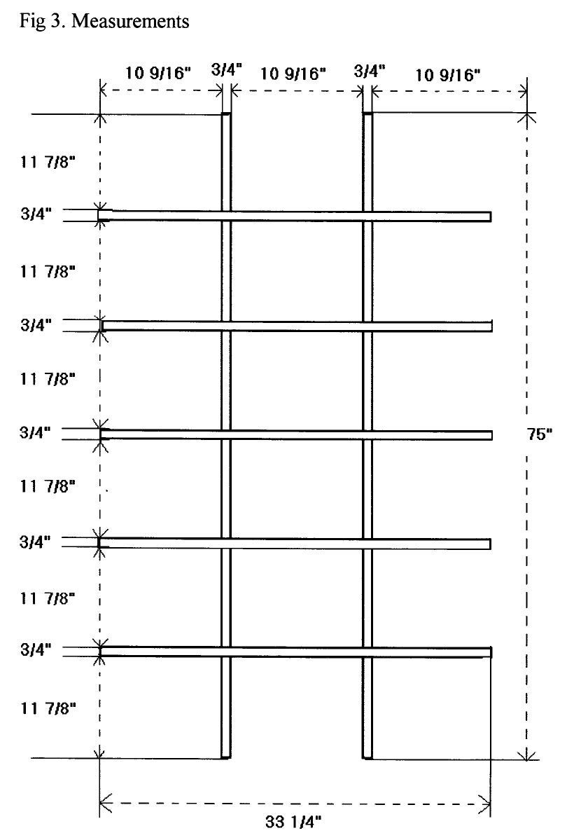

Insta French is a vinyl insert, [FIG. 1] No Tools required for installation. Insta French is made one piece of solid vinyl. Made to fit the dimension of standard doors and windows. [FIG. 2 & 3]

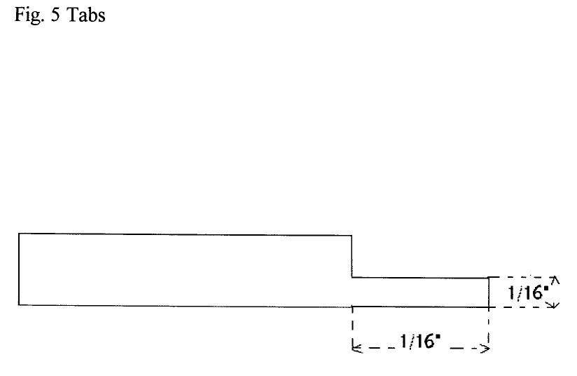

Each insert is ¼ inch thick. Each slat is ¾-inch wide. At the end of each slat is a 1/16-inch thick and 1/16-inch long tab [FIG. 5]. The tabs hold the Insta French Insert into door and windows. The extra 1/16 of an inch vinyl tab slides under the molding around the window frame to hold the insert into the window.

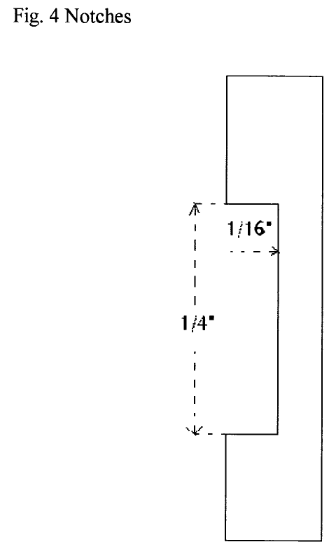

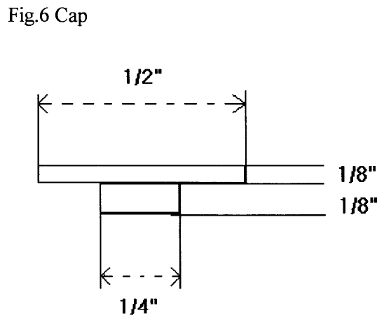

At the 2^{nd} horizontal slat from the top, and at the 2^{nd} horizontal slat from the bottom a ¼-inch notch. The ¼-inch vinyl is indented to ⅛ inch thick. The indented ¼-inch notch gives the vinyl insert ability to be flexible for packaging. [FIG. 4] Decorative caps are placed over notches during installation. When the vinyl insert is placed in the window opening caps (FIG. 6) are placed over the notches to make that insert firm, and holds the insert tight against the window glass.

The cap is made of the same vinyl as the insert, ¾-inch wide, ½-inch in length. With a tab centered on the bottom, ⅛-inch by ¼-inch thick. Caps cover the notches, [FIG. 6] and lock the Insta French insert into place.

Insta French Insert is molded into one solid piece of vinyl. It can be inserted into doors and windows in one easy step. Gives the illusion of stylist French doors. They are easily removed to wash windows and reinstalled in minutes.

Insta French vinyl insert is very strong and weather resistant. Insta French is for decorated purpose only.

1. What I claim as my invention is Insta French Door Inserts.

2. The tab at each of the cross bars FIG. 5 mounts ant the window frame with no brackets or retaining strips.

3. The flexible insert is in one piece with no parts to put together.

4. The 4 notches FIG. 4 is for folding the flexible vinyl insert.
